(19) United States
(12) Patent Application Publication
(10) Pub. No.: US 2025/0141636 A1
(43) Pub. Date: May 1, 2025

(54) UPLINK CONTROL INFORMATION FOR COHERENT JOINT TRANSMISSION CHANNEL STATE INFORMATION WITH TRANSMISSION RECEPTION POINT SELECTION

(71) Applicant: QUALCOMM Incorporated, San Diego, CA (US)

(72) Inventors: Jing DAI, Beijing (CN); Chao WEI, Beijing (CN); Liangming WU, Beijing (CN); Chenxi HAO, Beijing (CN); Yi HUANG, San Diego, CA (US); Yu ZHANG, San Diego, CA (US); Hyojin LEE, San Diego, CA (US); Hao XU, Beijing (CN)

(21) Appl. No.: 18/838,587

(22) PCT Filed: Apr. 29, 2022
(86) PCT No.: PCT/CN2022/090634

§ 371 Date: Aug. 14, 2024

(51) Int. Cl. H04L 5/00

(52) U.S. Cl. CPC H04L 5/0057

(57) ABSTRACT

The apparatus may be configured to transmit (or receive) CSI including a first CSI part (CSI part 1) having a fixed payload size and a second CSI part (CSI part 2) having a variable payload size indicated in the CSI part 1, at least one of the CSI part 1 or the CSI part 2 indicating one or more TRPs and to transmit (or receive) data in a CJT using the one or more TRPs indicated in the at least one of the CSI part 1 or the CSI part 2.

### TECHNICAL FIELD

The present disclosure relates generally to communication systems, and more particularly, to a coherent joint transmission (CJT) from multiple transmission reception points (TRPs). More specifically, the present disclosure relates to control information related to CJT.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a network node (e.g., a UE) or a component of a network node configured to transmit CSI including a first CSI part (CSI part 1) having a fixed payload size and a second CSI part (CSI part 2) having a variable payload size indicated in the CSI part 1, at least one of the CSI part 1 or the CSI part 2 indicating one or more TRPs and to transmit data in a CJT using the one or more TRPs indicated in the at least one of the CSI part 1 or the CSI part 2.

In an aspect of the disclosure, a method, a computer-readable medium, and an apparatus are provided. The apparatus may be a network entity (e.g., a BS) or a component of a network entity configured to receive CSI including a first CSI part (CSI part 1) having a fixed payload size and a second CSI part (CSI part 2) having a variable payload size indicated in the CSI part 1, at least one of the CSI part 1 or the CSI part 2 indicating one or more TRPs and to receive data in a CJT using the one or more TRPs indicated in the at least one of the CSI part 1 or the CSI part 2.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4A is a diagram illustrating characteristics of non-coherent joint transmission (NCJT).

FIG. 4B is a diagram illustrating characteristics of a CJT.

FIG. 5 is a diagram illustrating components of a precoder in some aspects of wireless communication.

FIG. 6 is a diagram illustrating a set of pre-coder components used in some aspects of CJT.

FIG. 7 is a diagram illustrating an example of a two part CSI in accordance with some aspect of the disclosure.

FIG. 8 is a call flow diagram of a method of wireless communication between two network nodes in accordance with some aspects of the disclosure.

FIG. 9 is a diagram illustrating a first CSI part that may be included in CSI.

FIG. 10 is a diagram illustrating a CSI part 1 that indicates, in a TRP selection field, one or more of a number (“X”) of TRPs (#TRP) over a set of all layers or a set of active layers and/or a number (“Y”) representing a number of a union of the TRPs associated with each layer in the set of all layers or the set of active layers.

FIG. 11 is a diagram illustrating that a per-TRP rank may be indicated in CSI part 1 in accordance with some aspects of the disclosure.

FIG. 12A illustrates a CSI part 1 that includes a per-layer TRP selection field.

FIG. 12B is a diagram 120 illustrating a CSI part 1 including a layer-common TRP selection field and/or a #TRPs for all layers (X) field.

FIG. 13 is a flowchart of a method of wireless communication.

FIG. 14 is a flowchart of a method of wireless communication.

FIG. 15 is a diagram illustrating an example of a hardware implementation for an apparatus.

FIG. 16 is a diagram illustrating an example of a hardware implementation for a network entity.

### DETAILED DESCRIPTION

In some aspects of wireless communication, joint transmission across multiple TRPs may be enabled. The joint transmission may be non-coherent JT (NCJT) in which data (layers) may be precoded separately on different TRPs, or may be CJT in which a same layer may be transmitted via multiple TRPs with phase coherence.

In some aspects, the coherence of CJT refers to a phase coherence between TRPs that may be transmitting a same layer as opposed to NCJT in which each layer is transmitted via a single TRP and phase coherence between the TRPs may not provide additional benefits. In some aspects of wireless communication, CJT may be extended to up to 4 TRPs, e.g., in a low frequency band such as FR1, based on a type-II codebook. In some aspects, providing additional TRPs for CJT effectively increases an antenna size for transmitting the low frequency transmission. In order to indicate a TRP selection (and an associated precoder, e.g., using the eType-II codebook) the present disclosure introduces mechanisms to provide information about TRP selection including mechanisms: (1) to indicate the TRP selection in CSI part 1 with a fixed payload size or (2) to indicate the TRP selection in CSI part 2 with a payload size based on the related CSI part 1.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

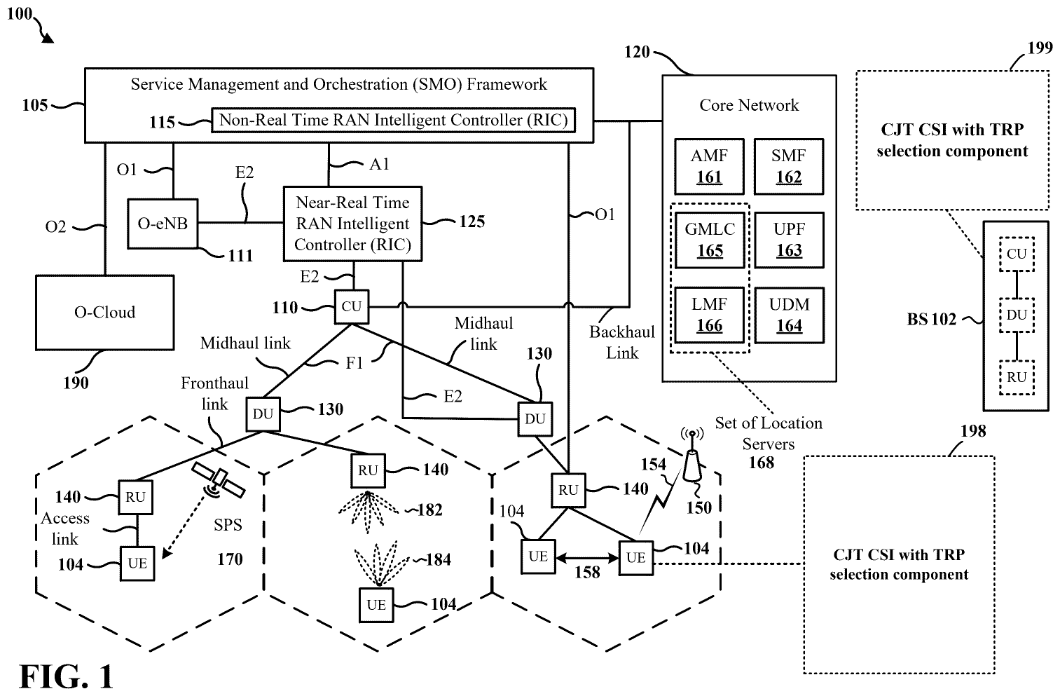

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an 02 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a CJT CSI with TRP selection component 198 configured to transmit CSI including a first CSI part (CSI part 1) having a fixed payload size and a second CSI part (CSI part 2) having a variable payload size indicated in the CSI part 1, at least one of the CSI part 1 or the CSI part 2 indicating one or more TRPs and to transmit data in a CJT using the one or more TRPs indicated in the at least one of the CSI part 1 or the CSI part 2. In certain aspects, the base station 102 may include a CJT CSI with TRP selection component 199 configured to receive CSI including a first CSI part (CSI part 1) having a fixed payload size and a second CSI part (CSI part 2) having a variable payload size indicated in the CSI part 1, at least one of the CSI part 1 or the CSI part 2 indicating one or more TRPs and to receive data in a CJT using the one or more TRPs indicated in the at least one of the CSI part 1 or the CSI part 2. Although the following description may be focused on 5G NR, the concepts described herein may be applicable to other similar areas, such as LTE, LTE-A, CDMA, GSM, and other wireless technologies.

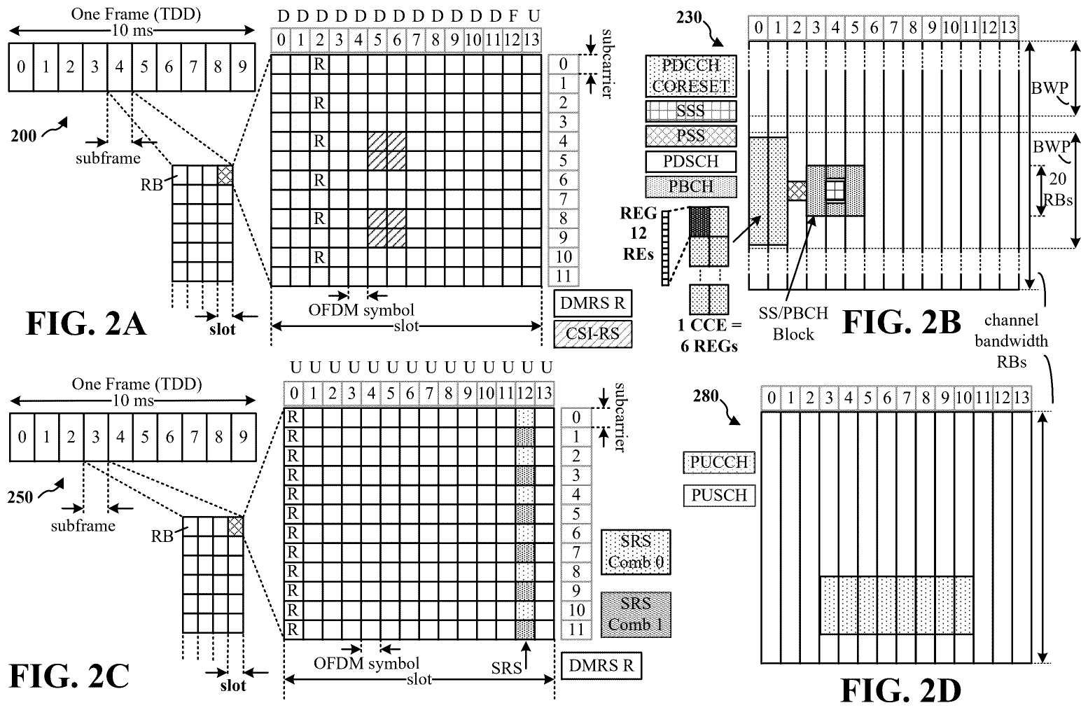

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies u 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 2″ *15 kHz, where u is the numerology 0 to 4. As such, the numerology u=0 has a subcarrier spacing of 15 kHz and the numerology u=4 has a subcarrier spacing of 240 kHz. The symbol length/duration is inversely related to the subcarrier spacing. FIGS. 2A-2D provide an example of normal CP with 14 symbols per slot and numerology u=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

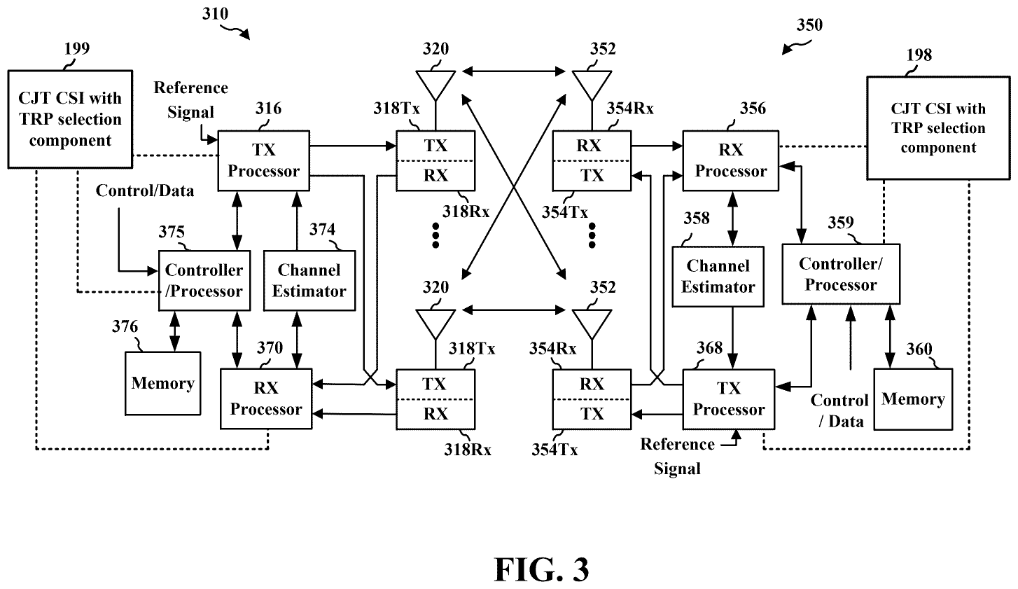

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the CJT CSI with TRP selection component 198 of FIG. 1. At least one of the TX processor 316, the RX processor 370, and the controller/processor 375 may be configured to perform aspects in connection with the CJT CSI with TRP selection component 199 of FIG. 1.

In some aspects of wireless communication, joint transmission across multiple TRPs may be enabled. The joint transmission may be non-coherent JT (NCJT) in which data (layers) may be precoded separately on different TRPs, or may be CJT in which a same layer may be transmitted via multiple TRPs with phase coherence.

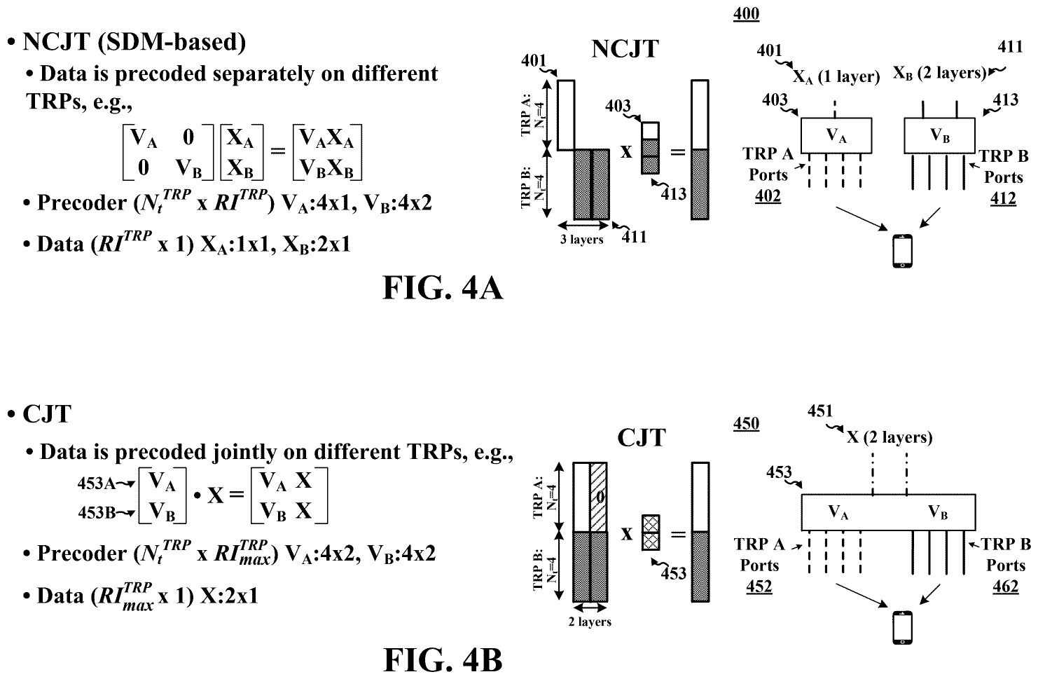

FIG. 4A is a diagram 400 illustrating characteristics of non-coherent joint transmission (NCJT). Diagram 400 illustrates that for NCJT a first set of layers (e.g., a set of one layer) associated with data X_{A} 401 may be associated with a set of TRP A ports 402 while a second set of layers (e.g., a set of two layers) associated with data X_{B} 411 may be associated with a set of TRP B ports 412. For NCJT, the data X_{A} 401 and X_{B} 411 may be precoded with a precoder matrix:

$$[ \begin{matrix}{V}_{A} & 0 \\ 0 & {V}_{B}\end{matrix} ]$$

The data is precoded separately on different TRPs. For example, the first column of the precoder matrix indicates that at a first instance, a first TRP will transmit data and the value “0” indicates that the second TRP will not transmit the data. Then, the second column indicates a “0” so that the first TRP does not transmit at the second instance and the second TRP will transmit. The data is represented by X_{A} and X_{B}, in which X_{A} is precoded based on V_{A} 403 and the data X_{B} is precoded based on V_{B} 413 for transmission over TRP A ports 402 and TRP B ports 412, respectively. FIG. 4A illustrates that the precoder matrix may have a dimension based on Nₜ^{TRP}×RI^{TRP}, where Nₜ^{TRP} is a value based on a number of transmission antennas of a TRP and RI^{TRP} corresponds to a rank indicator for the TRP, e.g., a number of layers for the TRP. In FIG. 2A, TRP A has four antenna ports and 1 layer, e.g., corresponding to V_{A}: 4×1, whereas TRP B has four antenna ports and two layers, e.g., corresponding to V_{B}: 4×2. The data may be based on the RI of the corresponding TRP x 1, e.g., R_{I}^{TRP}×1, so that the data for TRP A is X_{A}: 1×1 and the data for TRP B is X_{B}: 1×1 and 2. At 400, FIG. 2A shows the mapping of the data for transmission on the TRPs.

FIG. 4B is a diagram 450 illustrating characteristics of a CJT. Diagram 450 illustrates that, as opposed to NCJT, for CJT a first set of layers (e.g., a set of 2 layers) associated with joint data X 451 may be jointly precoded, e.g., based on precoder 453 (including a first precoder component V_{A} 453A and a second precoder component V_{B} 453B) to be transmitted from both the TRP A and TRP B in a coherent manner via TRP A ports 452 and TRP B ports 462. The precoder is shown as:

$$[ \begin{matrix}{V}_{A} \\ {V}_{B}\end{matrix} ]$$

FIG. 4B illustrates that the precoder matrix may have a dimension based on Nₜ^{TRP}×RIₘₐₓ^{TRD}, where Nₜ^{TRP} is a value based on a number of transmission antennas of a TRP and RIₘₐₓ^{TRP} max corresponds to a maximum rank indicator for the TRPs, e.g., a maximum number of layers for the TRPs. In FIG. 2B, TRP A and TRP each have four antenna ports and a maximum of 2 layers, so that V_{A}: 4×2 and V_{B}: 4×2. The data may be based on the RIₘₐₓ^{TBR}×1, e.g., RIₘₐₓ^{TRP} max×1, so that the data is X: 2×1. At 450, FIG. 2B shows the joint mapping of the data for transmission on the TRPs.

In some aspects, the coherence of CJT refers to a phase coherence between TRPs that may be transmitting a same layer as opposed to NCJT in which each layer is transmitted via a single TRP and phase coherence between the TRPs may not provide additional benefits. In some aspects of wireless communication, CJT may be extended to up to 4 TRPs, e.g., in a low frequency band such as FR1, based on a type-II codebook. In some aspects, providing additional TRPs for CJT effectively increases an antenna size for transmitting the low frequency transmission.

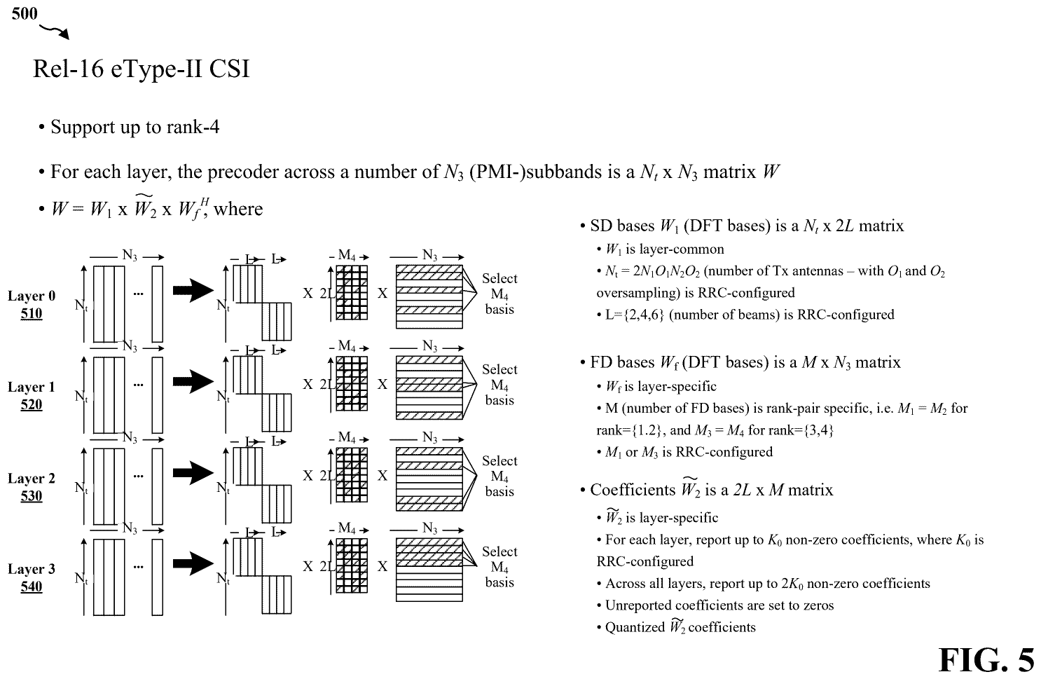

FIG. 5 is a diagram 500 illustrating components of a precoder in some aspects of wireless communication. Diagram 500 illustrates that, for each layer, e.g., Layer 0 510, Layer 1 520 Layer 2 530 and Layer 3 540, a precoder W may be generated based on a first matrix W₁ associated with a spatial domain (SD), a second matrix W_{f} or W_{f}^{H} associated with a frequency domain (FD), and a third matrix \tilde{W}₂ including a set of non-zero coefficients (NZCs). In some aspects, the first matrix W₁ may be a Nₜ by 2L matrix, where Nₜ is a value based on a number of transmission antennas and an oversampling and L is a number of beams used for the joint transmission and both Nₜ and L are RRC-configured. The first matrix W₁ in some aspects, may be selected from a set of SD basis matrixes (e.g., DFT bases) for the spatial domain. The first matrix may be common to layers to be transmitted via a joint transmission, e.g., a NCJT or a CJT.

The second matrix W_{f} or W_{f}^{H}, in some aspects, may be an M×N₃ matrix, where M may be an RRC-configured number of FD bases (e.g., FD DFT bases) and is rank-pair specific, i.e., M₁=M₂ for rank={1, 2} and M₃=M₄ for rank={3, 4}, and N₃ is a number of spatial domain bases. In some aspects, the second matrix W_{f} or W_{f}^{H} may be layer-specific such that a second matrix W_{f} or W_{f}^{H} includes a first set of selected FD bases associated with a first layer, where the first set of selected FD bases may, or may not, overlap, completely or partially, with a set of selected FD bases for a second matrix W_{f} or W_{f}^{H} associated with a second layer. The third matrix \tilde{W}₂, in some aspects, may be a 2L×M matrix including a set of NZCs. In some aspects, the third matrix \tilde{W}₂ is layer-specific and the CSI may report up to K₀ NZCs for each layer and up to 2K₀ NZCs across all the layers, where unreported coefficients are assumed to be, or are set to zero. The coefficients may be quantized based on a preconfigured and/or RRC configured quantized values.

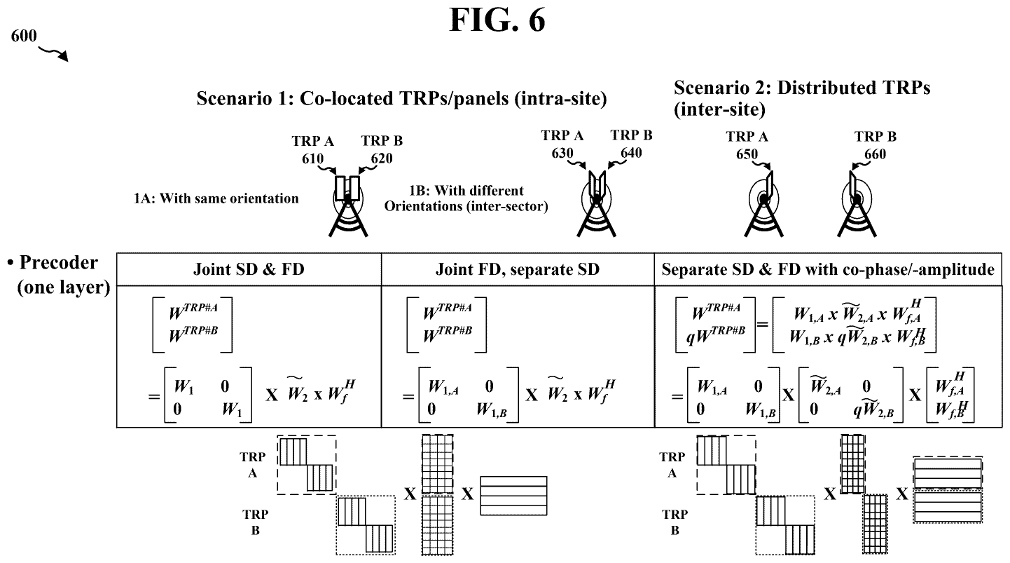

FIG. 6 is a diagram 600 illustrating a set of pre-coder components (e.g., SD component W₁, FD component W_{f} or W_{f}^{H}, and component \tilde{W}₂) used in some aspects of CJT. For example, in a first (intra-site) scenario (e.g., scenario 1A) associated with a CJT from multiple co-located TRPs (e.g., antennas at a same site) with a same spatial orientation, a same spatial domain matrix W₁ may be associated with (or used for) each TRP (e.g., for TRP A 610 and for TRP B 620). In a second (intra-site) scenario (e.g., scenario 1B) associated with a CJT for co-located TRPs (e.g., antennas at a same site) with a different spatial orientation, different spatial domain matrices W_{1,A} and W_{1,B} may be associated with (or used for) the different TRPs (e.g., spatial domain matrix W_{1,A} for TRP A 630 and spatial domain matrix W_{1,B} for TRP B 640).

Diagram 600 additionally illustrates that, in a third (inter-site) scenario (e.g., scenario 2) each component (e.g., SD component W₁, FD component W_{f} or W_{f}^{H}, and component \tilde{W}₂) may be selected independently. For example, different spatial domain matrices W_{1,A} and W_{1,B} may be associated with (or used for) the different TRPs at different sites (e.g., spatial domain matrix W_{1,A} for TRP A 650 and spatial domain matrix W_{1,B} for TRP B 660). Additionally, different frequency domain matrices W_{f,A}^{H} or W_{f,B}^{H} may be associated with (or used for) the different TRPs at different sites (e.g., spatial domain matrix W_{f,A}^{H} for TRP A 650 and spatial domain matrix W_{f,B}^{H} for TRP B 660). Finally, each of TRP A 650 and TRP B 660 may further be associated with different third components \tilde{W}_{2,A} and \tilde{W}^{2,B} respectively. In some aspects, one TRP may further be associated with an additional co-phase/-amplitude coefficient q.

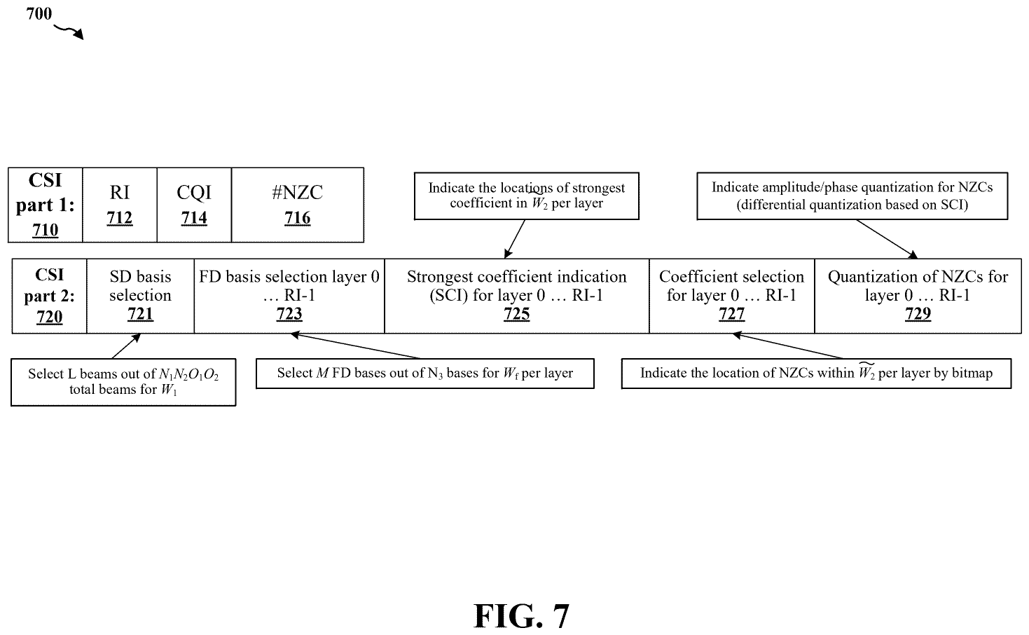

In some aspects of wireless communication, CSI is divided into two parts. For example, having multiple CSI parts may allow for larger CSI payload sizes. FIG. 7 is a diagram 700 illustrating an example of a two part CSI in accordance with some aspect of the disclosure. Diagram 700 illustrates a first CSI part (e.g., CSI part 1 710) that, in some aspects, has a fixed payload size and may have a smaller payload size than a second CSI part (e.g., CSI part 2 720). In some aspects, the CSI part 1 710 may include more significant (important) information than the CSI part 2 720 and may therefore be transmitted to achieve a higher reliability for the reception of the CSI part 1. As an example, the CSI part 1 may include rank indicator (RI) information and channel quality indicator (CQI) information. The CSI part 1 710, in some aspects, includes information used to determine a payload size of the CSI part 2 720. In some aspects, the CSI part 1 may include non-zero coefficients that help to enable the receiver to determine the payload size of the CSI part 2.

Diagram 700 illustrates example content of a CSI part 1 710, which in some aspects, includes (not necessarily in the order illustrated) an RI field 712 (indicating a number of layers associated with the corresponding transmission), a channel quality indication (CQI) field 714, and a number of non-zero coefficients (#NZC) field 716. In some aspects, both the RI field 712 and the #NZC field 716 may be used to determine a payload size of the CSI part 2 720. The CSI part 2 720, in some aspects, may include an SD basis selection indication field 721 (e.g., indicating a selection of L beams out of N₁N₂O₁O₂ total beams) for W^{1,A} as described above and a FD basis selection indication field 723 for each layer (e.g., indicating a selection of M FD bases out of N₃ bases for W_{f} or W_{f}^{H} for each layer 0 to RI-1).

The CSI part 2 720 may further include indications of parameters associated with the NZCs indicated in #NZC field 716. In some aspects, the CSI part 2 720 may include a strongest coefficient indication 725 for each of the layers 0 to RI-1, a coefficient selection indication 727 for each of the layers 0 to RI-1, and a quantization of NZCs indication 729 for each of the layers 0 to RI-1. The strongest coefficient indication 725, in some aspects, indicates the location(s) of the strongest coefficients (e.g., in a matrix \tilde{W}₂) for each of the layers 0 to RI-1. The coefficient selection indication 727 indicates the location of the NZCs within the matrix \tilde{W}₂ for each of the layers 0 to RI-1 (e.g., using a bitmap per layer). The quantization of NZCs indication 729, in some aspects, indicates an amplitude and/or phase quantization for NZCs in each layer (e.g., based on the strongest coefficient indication 725 for the layer). In some aspects of the disclosure, additional information for a CJT is provided in one or more of CSI part 1 or CSI part 2.

In some aspects of wireless communication, a CSI indicating TRP selection for CJT may be associated with an extended Type II (eType-II) codebook. While a fixed payload size may be associated with a first part of the CSI, a payload size of the second part of the CSI may be variable and may depend (or be based on) a number of selected TRPs. The variable payload size for the second part of the CSI may be based on one or more of (1) different sizes of W₁ for SD basis selection indication (e.g., via the SD basis selection indication field 721), (2) different sizes of W_{f} for FD basis selection indication (e.g., via the indication of the FD basis selection indication field 723), and/or (3) different sizes for a NZC location indication 727, a strongest coefficient indication 725, and/or a quantization of NZCs indication 729 associated with W₂. In order to indicate the TRP selection (and the associated precoder, e.g., using the eType-II codebook) the present disclosure introduces mechanisms to provide information about TRP selection including mechanisms: (1) to indicate the TRP selection in CSI part 1 with a fixed payload size or (2) to indicate the TRP selection in CSI part 2 with a payload size based on the related CSI part 1.

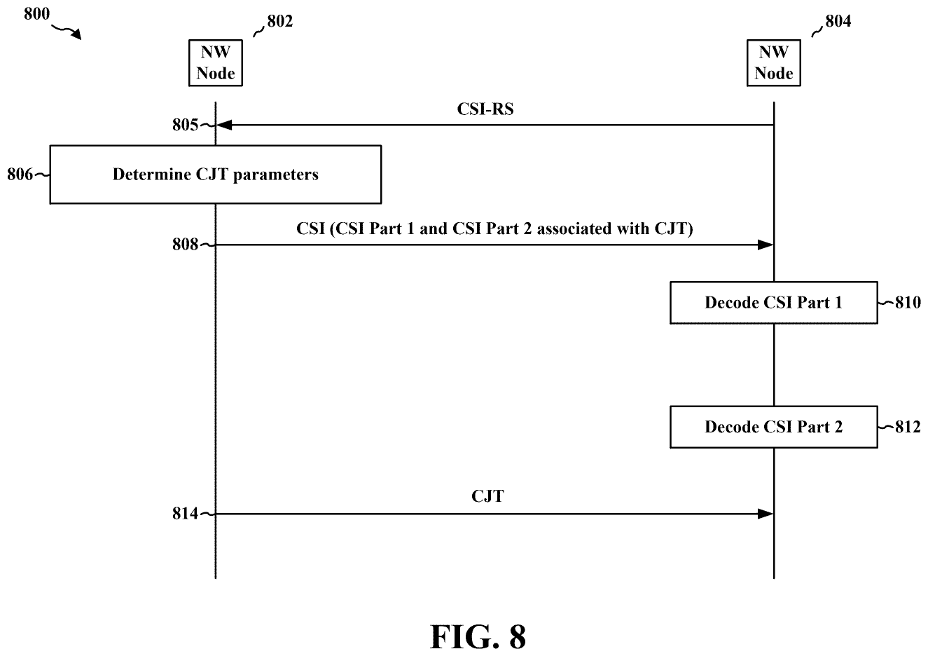

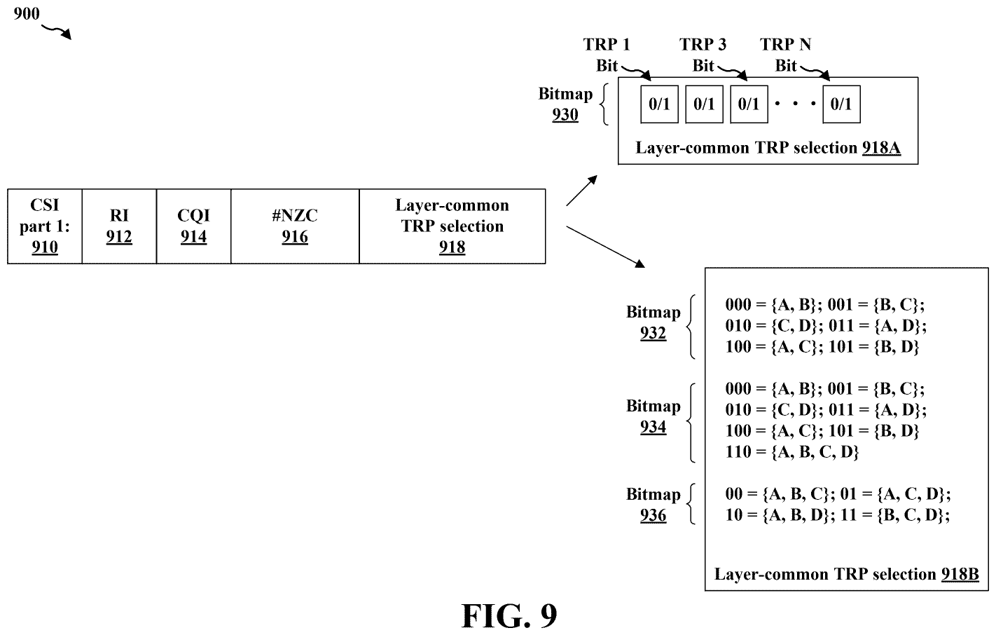

FIG. 8 is a call flow diagram 800 of a method of wireless communication between two network nodes (e.g., network node 802 and network node 804) in accordance with some aspects of the disclosure. The network nodes 802 and 804, in some aspects, may each be one of a UE or a base station with multiple TRPs. At 806, the network node 802 may determine a set of CJT parameters. The CJT parameters may be determined at 806 based on a set of previously-received CSI-RS 805 from the network node 804. Based on the CJT parameters determined at 806, the network node 802 may transmit CSI 808 including a first CSI part (CSI part 1) having a fixed payload size and a second CSI part (CSI part 2) having a variable payload size indicated in the CSI part 1. In some aspects, at least one of the CSI part 1 or the CSI part 2 indicates one or more TRPs for the CJT of data, e.g., at 814. FIGS. 9-12B illustrate different formats that the CSI 808 may take to indicate a selected set of TRPs for a CJT.

FIG. 9 is a diagram 900 illustrating a first CSI part (e.g., CSI Part 1 910) that may be included in CSI 808. The first CSI part, in some aspects, indicates a layer-common set of selected TRPs for a CJT in accordance with some aspects of the disclosure. Diagram 900 illustrates that a first part of CSI (e.g., CSI Part 1 910) may include a RI field 912, a CQI field 914, an #NZC field 916, and a layer-common TRP selection field 918. The layer-common TRP selection field 918 may indicate a set of TRPs associated with different layers being transmitted via the CJT. The first CSI part may have a payload size that is fixed, e.g., the same regardless of the number of TRPs indicated. The layer-common TRP selection field 918 may be implemented as a bitmap-based layer-common TRP selection field 918A. The layer-common TRP selection field 918A may include a bitmap 930 that includes a number of bits equal to a number (N) of possible TRPs available for the CJT. For example, for N=4, the bitmap 930 may include a set of 4 bits with each bit corresponding to a particular TRP in the set of four possible TRPs. As an example, a value of “0” may indicate that the corresponding TRP is not selected, and a value of “1” may indicate that the corresponding TRP is selected. As an example, a first bit of the bitmap may correspond to TRP A, a second bit of the bitmap may correspond to TRP B, a third bit of the bitmap may correspond to TRPC, and a fourth bit of the bitmap may correspond to TRPD. In such an example, a bitmap value of {0101} may indicate that TRP B and TRP D are selected for the CJT data transmission. Alternatively, a value of “0” may indicate that the corresponding TRP is selected, and a value of “1” may indicate that the corresponding TRP is not selected. In such an example, the bitmap value of {0101} would indicate that TRP A and TRP C are selected.

In some aspects, as shown at 918B, a limited number of combinations of a configured number of TRPs may be possible and a bitmap (e.g., bitmap 932, bitmap 934, or bitmap 936) may be used to identify a selected set of TRPs. For example, the set of possible TRPs may include sets of two TRPs as in bitmap 932. For example, in the bitmap 932, the bitmap has three bits, with “000” indicating that TRP A and TRP B are selected for the CJT transmission of data, whereas “010” indicates that TRP C and TRP D are selected for the CJT transmission. Each of the different values of the bitmap may correspond to a different combination of TRPs. In other examples, the set of possible TRPs may include the sets of two TRPs and a set of four TRPs as in bitmap 934, or sets of 3 TRPs as in bitmap 936, where the number of bits used to identify the selected TRPs depends on the total number of possible sets of TRPs. Bitmap 932 illustrates that, for a bitmap corresponding to the possible groups of two TRPs (where the group size may be configured to be n_{TRP}) from a set of four TRPs (where the total number of TRPs may be N_{TRP}), three bits are sufficient to identify the possible groups of two TRPs. In general, for a fixed group size and number of TRPs, the number of bits used may be given by

$$⌈ {log}_{2} ( \begin{matrix}{N}_{TRP} \\ {n}_{TRP}\end{matrix} ) ⌉$$

(e.g., the smallest integer larger than or equal to the base 2 logarithm of the number of combination of n_{TRP} elements from a set of N_{TRP} elements). In some aspects, the selected TRPs may be indicated via channel state information reference signal (CSI-RS) resource indicator (CRI) that indicates the one or more TRPs. For example, a plurality of sets of CSI-RS resources indicated by a CRI may be mapped to a corresponding plurality of sets of selected TRP, such that a CRI may indicate a selected set of TRPs in addition to CSI-RS resources.

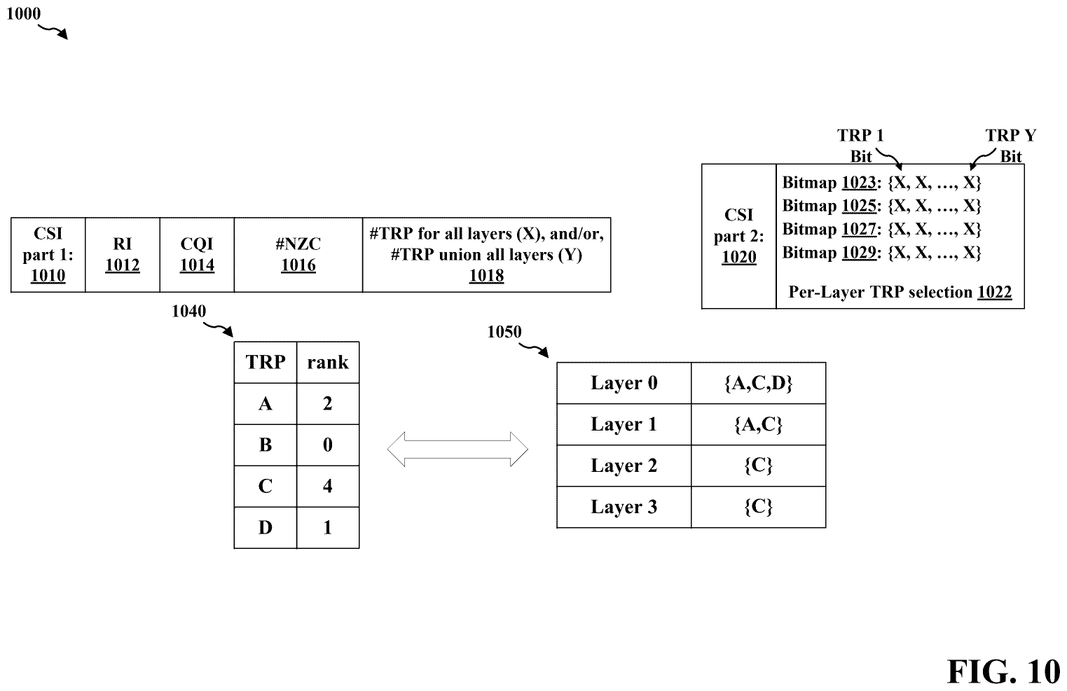

An indication of the one or more TRPs, in some aspects, may be indicated separately for each layer of communication using the one or more TRPs. The separate indications for each layer, in some aspects, are included in the CSI part 2. The CSI part 1, in some aspects, may indicate a total number of TRP selections for all layers and a number of different TRPs in the TRP selections for the different layers. FIG. 10 is a diagram 1000 illustrating a CSI part 1 1010 that includes RI 1012, CQI 1014, #NZC 1016, and that indicates, in a TRP selection field 1018, one or more of a number (“X”) of TRPs (#TRP) over a set of all layers or a set of active layers and/or a number (“Y”) representing a number of a union of the TRPs associated with each layer in the set of all layers or the set of active layers. The indication in the CSI part 1 of the number X and/or the number Y may, in some aspects, be used to determine a payload size of the CSI part 2. For example, for a situation as identified in table 1040 of FIG. 10 in which a first TRP (TRP A) is associated with two layers (has a rank of 2), a second TRP (TRP B) is not associated with any layers (has a rank of 0), a third TRP (TRP C) is associated with four layers (has a rank of 4), and a fourth TRP (TRP D) is associated with one layer (has a rank of 1). The CSI part 1 may indicate that the total number (X) of TRPs associated with the different layers separately is seven (e.g., TRP A is associated with 2 layers, TRP C is associated with 4 layers, and the TRP D is associated with 1 layer for a total number of 7) and/or that the total number (Y) of TRPs involved in the CJT is three (TRP A, TRP C, and TRP D).

FIG. 10 also illustrates that in some aspects, a number of TRPs in each layer may be maintained (e.g., may be equal to) or may decrease with an increase in a layer index. In some aspects, a first set of selected TRPs of a first layer having a larger index may be a subset of a second set of selected TRPs of a second layer having a smaller index. For example, referring to table 1050 of FIG. 10, a first layer (e.g., layer 1 or layer 2) having a larger index may select an associated set of TRPs (e.g., {A, C} or {C}, respectively) from the set of TRPs (e.g., {A, C, D} or {A, C}, respectively) associated with a second layer (e.g., layer 0 or layer 1, respectively) having the smaller index. For example, layer 0 indicates TRPs {A, C, D}, and layer 1 has a larger layer index and a smaller set of TRPs, e.g., a subset of the TRPs selected for layer 0. Layer 2 has a higher index than layer 1 and a subset of the TRPs selected for layer 1. Layer 3 has a higher index than layer 2 and the same number of TRPs as for layer 2.

In some aspects, the information included in the TRP selection field 1018 may be used, e.g., as part of decoding the CSI part 1 at 810, to determine, or identify, a payload size for the CSI part 2 1020. The CSI part 2 may then be decoded at 812. For example, the number X of TRPs over the set of all layers or the set of active layers may be used to determine a payload size of the NZC location indication (e.g., NZC location indication 727) by being associated with a size of \tilde{W}₂ within which the NZCs are located (e.g., a total number of selected SD bases and/or a total number of selected FD bases for all TRPs across all layers). The number Y may be used to determine a payload size of the SD basis selection, (e.g. a total number of selected SD bases union all TRPs, assuming a common SD basis selection for a same TRP at different layers).

For example, CSI 1020, may include a per-layer TRP selection field 1022 including a set of bitmaps (e.g., bitmap 1023, bitmap 1025, bitmap 1027, and bitmap 1029) that each correspond to one layer and may be used to indicate the TRPs associated with each layer. Each bitmap may include a set of Y bits corresponding to the number Y of unique TRPs associated with the different layers and the payload size may be determined based on the number of bits required for the different bitmaps 1023-1029 (e.g., a number of (active) layers times the number (Y) of TRPs or RI*N_{TRP}).

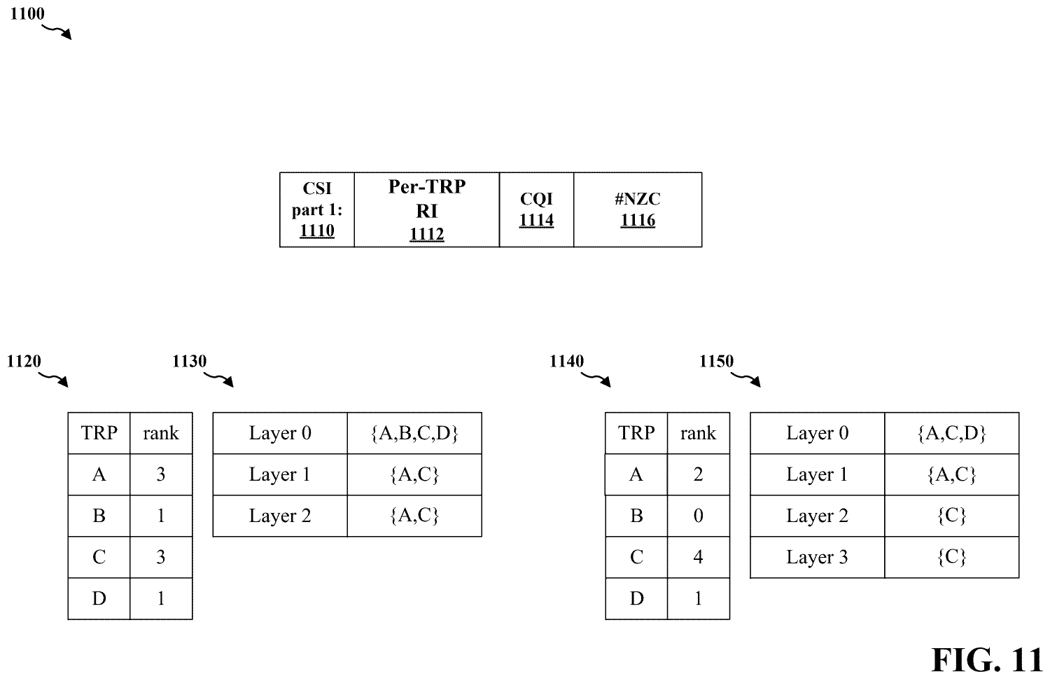

In some aspects, the CSI part 1 includes a rank indicator per TRP of the one or more TRPs. FIG. 11 is a diagram 1100 illustrating that a per-TRP rank may be indicated in CSI part 1 in accordance with some aspects of the disclosure. Diagram 1100 illustrates that a CSI part 1 1110 may include CQI 1114, #NZC 1116, and a per-TRP RI field 1112 similar to the RI field 712 or 912 included in CSI part 1 710 or 910, but indicating a rank for each TRP. In some aspects, this will represent an increase in the fixed payload size of the CSI part 1 to accommodate separate RIs for each TRP. For example, for a possible rank of one to four (e.g., a minimum rank indicator is 1) and a set of four possible TRPs, a set of six additional bits may be included in the CSI part 1 (e.g., two bits per TRP minus the two bits previously used to signal the RI). In some aspects in which a TRP may be associated with a rank of zero (where the rank indicator of zero indicates that the TRP is not selected) an additional 10 bits may be introduced (e.g., three bits per TRP minus the two bits previously used to signal the RI). Diagram 1120 and 1140 indicate a per-TRP rank based on a correspond mapping 1130 and 1150, respectively, of layers to TRPs. The CSI part 2 payload size associated with CSI part 1110 may be determined by the indication of the per-TRP RIs in the per-TRP RI field 1112.

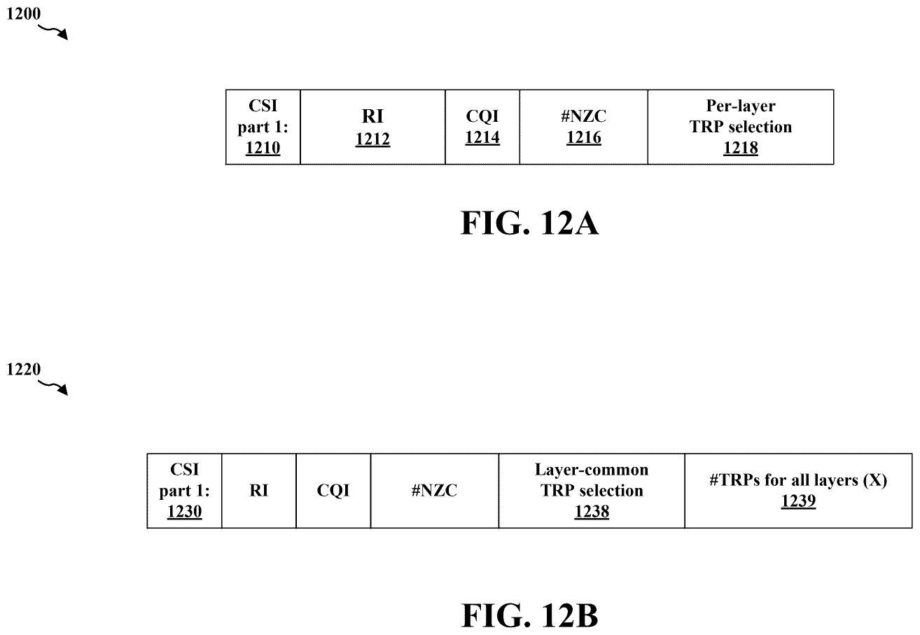

In some aspects, the indication of the one or more TRPs is included in the CSI part 1, and the fixed payload size is based on a maximum rank. FIG. 12A is a diagram 1200 illustrates a CSI part 1 that includes a per-layer TRP selection field 1218. In order to account for all possible combination of layers and TRPs, the per-layer TRP selection field 1218 may be configured to have a size based on the number of TRPs and a maximum rank that may be associated with each TRP. Accordingly, the payload size of the CSI part 1 may increase by the number of TRPs times the maximum rank to provide a bitmap covering all the possible combinations of rank per TRP and/or TRPs selected per layer. The CSI part 2 payload size associated with CSI part 1 1210 may be determined by the indication of the per-layer TRP selection in the per-layer TRP selection field 1218. As illustrated, the CSI part 1 may also include RI 1212, CQI 1214, #NZC 1216.

In some aspects, a TRP selection that is common to multiple layers is indicated in the CSI part 1, and a layer specific TRP selection is indicated in the CSI part 2. FIG. 12B is a diagram 1220 illustrating a CSI part 1 1230 including a layer-common TRP selection field 1238 and a #TRPs for all layers (X) field 1239. The indication included in the layer-common TRP selection field 1238 and/or the #TRPs for all layers (X) field 1239 may then be used to determine a payload size for a layer-specific TRP selection field (similar to per-layer TRP selection field 1022 in CSI part 2 1020 of FIG. 10). For example, from indication included in the layer-common TRP selection field 1238 and/or the #TRPs for all layers (X) field 1239, total number of TRPs and an associated RI may be identified to generate a set of RI bitmaps with Y bits in each bitmap corresponding to the number of TRPs indicated in the layer-common TRP selection field 1238.

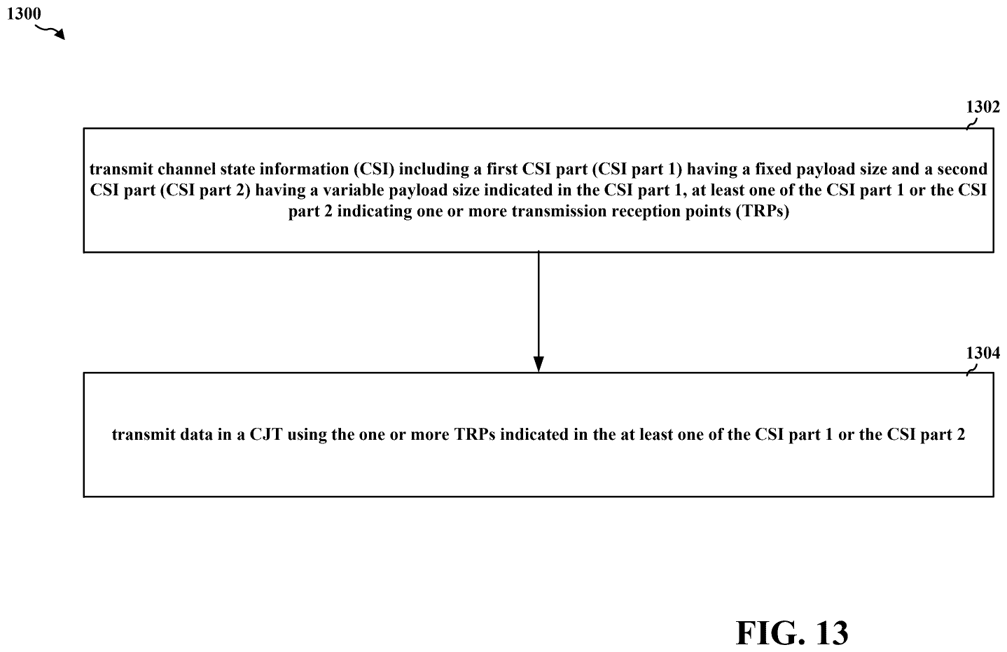

FIG. 13 is a flowchart 1300 of a method of wireless communication. The method may be performed by a UE (e.g., the UE 104; the network node 802; the apparatus 1504). At 1302, the UE may transmit CSI including a first CSI part (CSI part 1) having a fixed payload size and a second CSI part (CSI part 2) having a variable payload size indicated in the CSI part 1. At least one of the CSI part 1 or the CSI part 2, in some aspects, may indicate one or more TRPs. For example, 1302 may be performed by CJT CSI with TRP selection component 198. In some aspects, the CSI part 1 includes an indication of the one or more TRPs that is common to each layer of communication using the one or more TRPs. The indication of the one or more TRPs in some aspects, may be one of a bitmap indicating the one or more TRPs, an indication of the one or more TRPs from sets of one or more TRPs are restricted to a fixed number, a set of bits indicating a set of TRPs including the one or more TRPs from a preconfigured plurality of sets of TRPs mapped to a plurality of possible values for the set of bits, or CRI that indicates the one or more TRPs. For example, referring to FIG. 9, a CSI part 1 910 includes a layer-common TRP selection field 918A that may indicate a TRP selection via one or the bitmaps 930-936. In some aspects, the variable payload size of the CSI part 2 is based on a rank indicator and a number of TRPs in the one or more TRPs. The indication in the CSI part 2, in some aspects, includes RI×N_{TRP} bits, where RI corresponds to a rank indicator and N_{TRP} corresponds to a number of the one or more TRPs. For example, referring to FIG. 10, a CSI part 2 1020 may include a set of bitmaps 1023-1029 including a set of N_{TRP} bits for each of the layers accounted for in the RI.

In some aspects, the indication of the one or more TRPs may be indicated separately for each layer of communication using the one or more TRPs. For example, referring to FIG. 12A, a per-layer TRP selection field 1218 may be included in CSI part 1 1210. The indication, in some aspects, is included in the CSI part 2. For example, referring to FIG. 10, a CSI part 2 1020 may include a set of bitmaps 1023-1029 including a set of N_{TRP} bits for each of the layers accounted for in the RI. In some aspects, the CSI part 1 indicates a total number of TRP selections for all layers and a number of different TRPs in the TRP selections. The CSI part 1, in some aspects, includes a rank indicator per TRP of the one or more TRPs. In some aspects, a rank indicator per TRP of the one or more TRPs of zero indicates that the TRP is not selected. The rank indicator per TRP of the one or more TRPs, in some aspects, may be associated with a minimum rank indicator of 1. The indication of the one or more TRPs, in some aspects, is included in the CSI part 1, and the fixed payload size is based on a maximum rank.

In some aspects, a TRP selection that is common to multiple layers is indicated in the CSI part 1, and a layer specific TRP selection is indicated in the CSI part 2. A number of NZCs indicated in the CSI part 1, in some aspects, corresponds to a total number of NZCs across the one or more TRPs. In some aspects, a number of TRPs in each layer equals or decreases with an increase in a layer index (e.g., layers associated with larger indexes are associated with a number of TRPs that is equal to or less than a number of TRPs associated with lower indexes). In some aspects, a first set of selected TRPs of a first layer having a larger index is a subset of a second set of selected TRPs of a second layer having a smaller index. The overall rank of the CJT with multiple TRPs is a maximum rank across each of the multiple TRPs.

At 1304, the UE may transmit, and a network node (e.g., another UE or a base station) may transmit, data in a CJT using the one or more TRPs indicated in the at least one of the CSI part 1 or the CSI part 2. For example, 1304 may be performed by CJT CSI with TRP selection component 198.

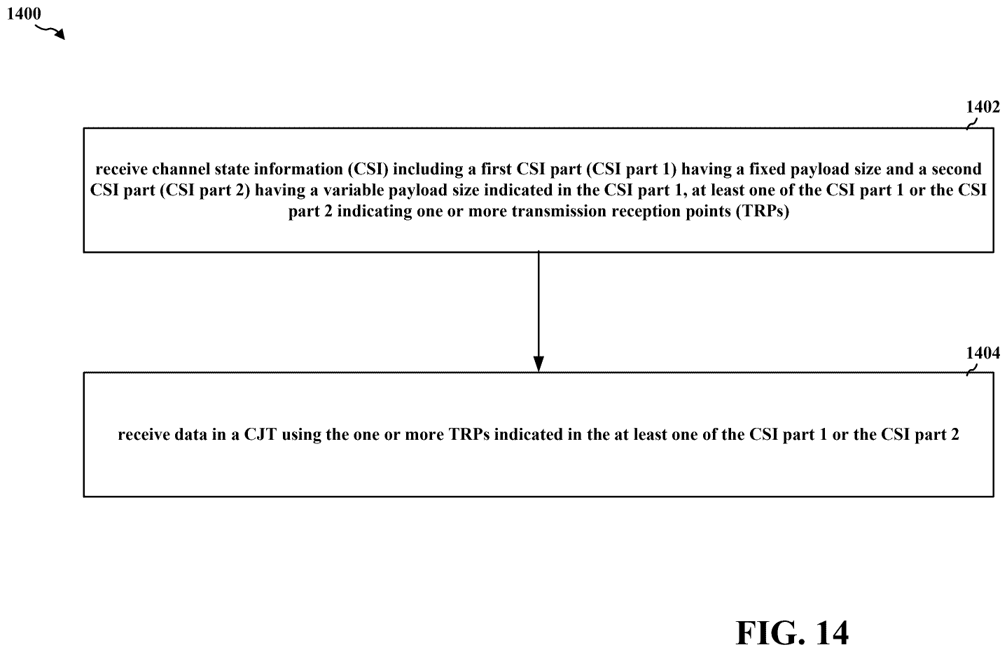

FIG. 14 is a flowchart 1400 of a method of wireless communication. The method may be performed by a network node such as a base station or a component of a base station (e.g., the BS 102, 310; the CU 110; the DU 130; the RU 140; the network node 804; the network entity 1602). At 1402, the base station may receive CSI including a first CSI part (CSI part 1) having a fixed payload size and a second CSI part (CSI part 2) having a variable payload size indicated in the CSI part 1. At least one of the CSI part 1 or the CSI part 2, in some aspects, may indicate one or more TRPs. For example, 1402 may be performed by CJT CSI with TRP selection component 199. In some aspects, the CSI part 1 includes an indication of the one or more TRPs that is common to each layer of communication using the one or more TRPs. The indication of the one or more TRPs in some aspects, may be one of a bitmap indicating the one or more TRPs, an indication of the one or more TRPs from sets of one or more TRPs are restricted to a fixed number, a set of bits indicating a set of TRPs including the one or more TRPs from a preconfigured plurality of sets of TRPs mapped to a plurality of possible values for the set of bits, or CRI that indicates the one or more TRPs. For example, referring to FIG. 9, a CSI part 1 910 includes a layer-common TRP selection field 918A that may indicate a TRP selection via one or the bitmaps 930-936. In some aspects, the variable payload size of the CSI part 2 is based on a rank indicator and a number of TRPs in the one or more TRPs. The indication in the CSI part 2, in some aspects, includes RI×N_{TRP} bits, where RI corresponds to a rank indicator and N_{TRP} corresponds to a number of the one or more TRPs. For example, referring to FIG. 10, a CSI part 2 1020 may include a set of bitmaps 1023-1029 including a set of N_{TRP} bits for each of the layers accounted for in the RI.

In some aspects, the indication of the one or more TRPs may be indicated separately for each layer of communication using the one or more TRPs. For example, referring to FIG. 12A, a per-layer TRP selection field 1218 may be included in CSI part 1 1210. The indication, in some aspects, is included in the CSI part 2. For example, referring to FIG. 10, a CSI part 2 1020 may include a set of bitmaps 1023-1029 including a set of N_{TRP} bits for each of the layers accounted for in the RI. In some aspects, the CSI part 1 indicates a total number of TRP selections for all layers and a number of different TRPs in the TRP selections. The CSI part 1, in some aspects, includes a rank indicator per TRP of the one or more TRPs. In some aspects, a rank indicator per TRP of the one or more TRPs of zero indicates that the TRP is not selected. The rank indicator per TRP of the one or more TRPs, in some aspects, may be associated with a minimum rank indicator of 1. The indication of the one or more TRPs, in some aspects, is included in the CSI part 1, and the fixed payload size is based on a maximum rank.

In some aspects, a TRP selection that is common to multiple layers is indicated in the CSI part 1, and a layer specific TRP selection is indicated in the CSI part 2. A number of NZCs indicated in the CSI part 1, in some aspects, corresponds to a total number of NZCs across the one or more TRPs. In some aspects, a number of TRPs in each layer equals or decreases with an increase in a layer index (e.g., layers associated with larger indexes are associated with a number of TRPs that is equal to or less than a number of TRPs associated with lower indexes). In some aspects, a first set of selected TRPs of a first layer having a larger index is a subset of a second set of selected TRPs of a second layer having a smaller index. The overall rank of the CJT with multiple TRPs is a maximum rank across each of the multiple TRPs.

At 1404, the base station may receive, and a network node (e.g., another UE) may transmit, data in a CJT using the one or more TRPs indicated in the at least one of the CSI part 1 or the CSI part 2. For example, 1404 may be performed by CJT CSI with TRP selection component 199.

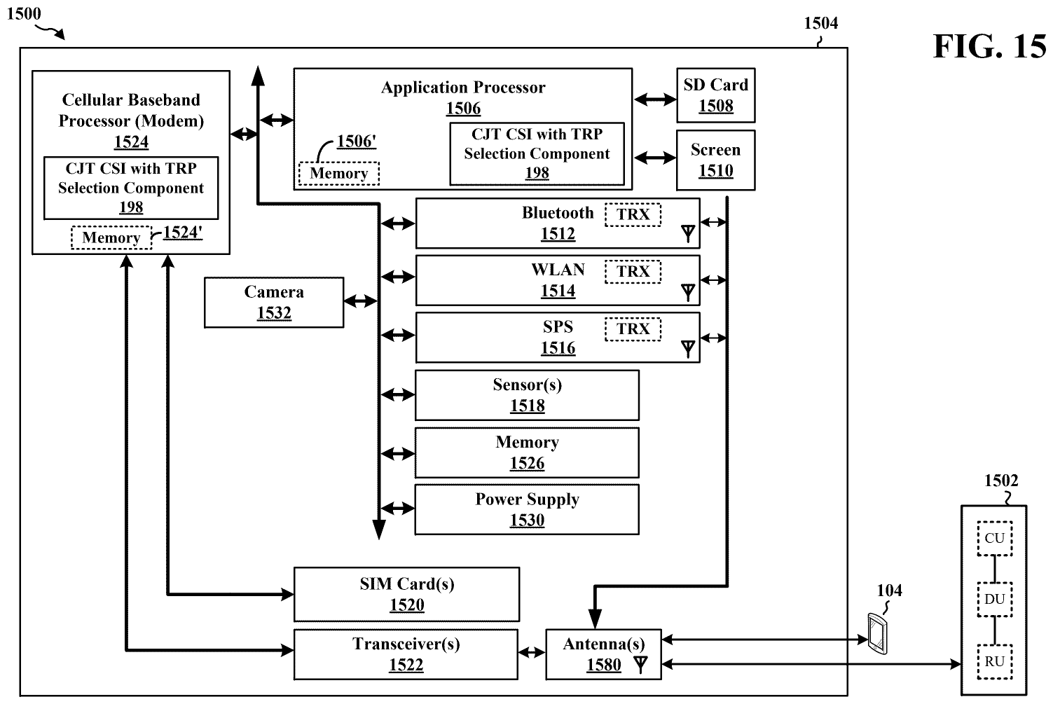

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include a cellular baseband processor 1524 (also referred to as a modem) coupled to one or more transceivers 1522 (e.g., cellular RF transceiver). The cellular baseband processor 1524 may include on-chip memory 1524′. In some aspects, the apparatus 1504 may further include one or more subscriber identity modules (SIM) cards 1520 and an application processor 1506 coupled to a secure digital (SD) card 1508 and a screen 1510. The application processor 1506 may include on-chip memory 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor 1524 communicates through the transceiver(s) 1522 via one or more antennas 1580 with the UE 104 and/or with an RU associated with a network entity 1502. The cellular baseband processor 1524 and the application processor 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor 1524 and the application processor 1506 are each responsible for general processing, including the execution of software stored on the computer-readable medium/memory. The software, when executed by the cellular baseband processor 1524/application processor 1506, causes the cellular baseband processor 1524/application processor 1506 to perform the various functions described supra. The computer-readable medium/memory may also be used for storing data that is manipulated by the cellular baseband processor 1524/application processor 1506 when executing software. The cellular baseband processor 1524/application processor 1506 may be a component of the UE 350 and may include the memory 360 and/or at least one of the TX processor 368, the RX processor 356, and the controller/processor 359. In one configuration, the apparatus 1504 may be a processor chip (modem and/or application) and include just the cellular baseband processor 1524 and/or the application processor 1506, and in another configuration, the apparatus 1504 may be the entire UE (e.g., see 350 of FIG. 3) and include the additional modules of the apparatus 1504.

As discussed supra, the CJT CSI with TRP selection component 198 is configured to transmit CSI including a first CSI part (CSI part 1) having a fixed payload size and a second CSI part (CSI part 2) having a variable payload size indicated in the CSI part 1, at least one of the CSI part 1 or the CSI part 2 indicating one or more TRPs and to transmit data in a CJT using the one or more TRPs indicated in the at least one of the CSI part 1 or the CSI part 2. The CJT CSI with TRP selection component 198 may be within the cellular baseband processor 1524, the application processor 1506, or both the cellular baseband processor 1524 and the application processor 1506. The CJT with TRP CSI with TRP selection component 198 and/or another component that may be included in the apparatus 1504 may be configured to perform any of the aspects of the flowchart in FIG. 14 and/or the aspects performed by the network node 802 in FIG. 8. The CJT CSI with TRP selection component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1504 may include a variety of components configured for various functions. In one configuration, the apparatus 1504, and in particular the cellular baseband processor 1524 and/or the application processor 1506, includes means for transmitting CSI including a first CSI part (CSI part 1) having a fixed payload size and a second CSI part (CSI part 2) having a variable payload size indicated in the CSI part 1, at least one of the CSI part 1 or the CSI part 2 indicating one or more TRPs and means for transmitting data in a CJT using the one or more TRPs indicated in the at least one of the CSI part 1 or the CSI part 2. The means may be the CJT CSI with TRP selection component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

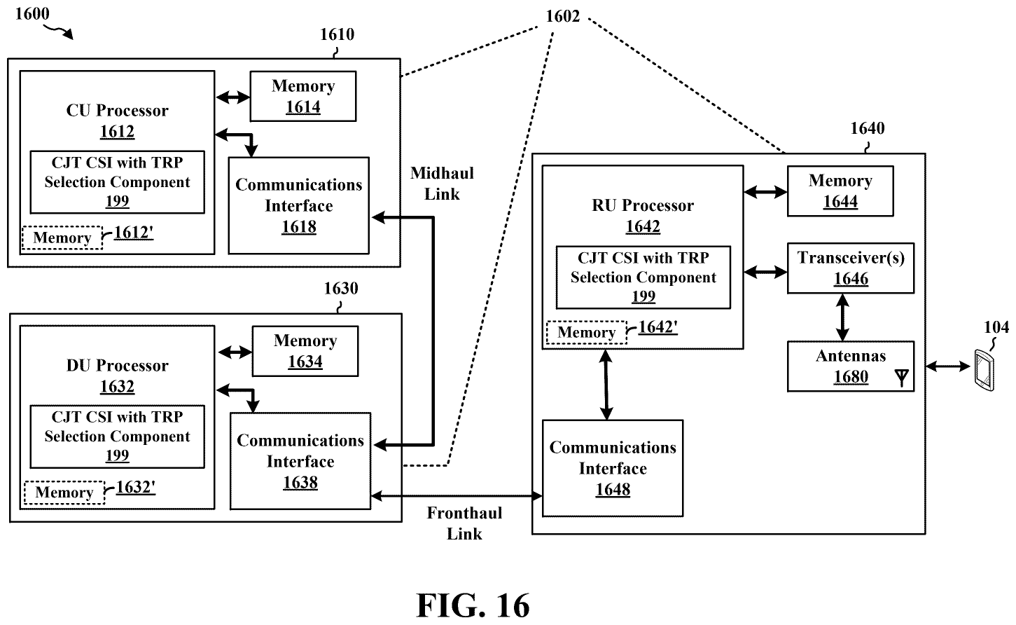

FIG. 16 is a diagram 1600 illustrating an example of a hardware implementation for a network entity 1602, which may also be referred to as a network node. The network entity 1602 may be a BS, a component of a BS, or may implement BS functionality. The network entity 1602 may include at least one of a CU 1610, a DU 1630, or an RU 1640. For example, depending on the layer functionality handled by the component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include a CU processor 1612. The CU processor 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include a DU processor 1632. The DU processor 1632 may include on-chip memory 1632′. In some aspects, the DU 1630 may further include additional memory modules 1634 and a communications interface 1638. The DU 1630 communicates with the RU 1640 through a fronthaul link. The RU 1640 may include an RU processor 1642. The RU processor 1642 may include on-chip memory 1642′. In some aspects, the RU 1640 may further include additional memory modules 1644, one or more transceivers 1646, antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the CJT CSI with TRP selection component 199 is configured to receive CSI including a first CSI part (CSI part 1) having a fixed payload size and a second CSI part (CSI part 2) having a variable payload size indicated in the CSI part 1, at least one of the CSI part 1 or the CSI part 2 indicating one or more TRPs and to receive data in a CJT using the one or more TRPs indicated in the at least one of the CSI part 1 or the CSI part 2. The CJT CSI with TRP selection component 199 may be within one or more processors of one or more of the CU 1610, DU 1630, and the RU 1640. The CJT CSI with TRP selection component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1602 may include a variety of components configured for various functions. In one configuration, the network entity 1602 includes means for receiving CSI including a first CSI part (CSI part 1) having a fixed payload size and a second CSI part (CSI part 2) having a variable payload size indicated in the CSI part 1, at least one of the CSI part 1 or the CSI part 2 indicating one or more TRPs and means for receiving data in a CJT using the one or more TRPs indicated in the at least one of the CSI part 1 or the CSI part 2. The TRP selection component 199 and/or another component that may be included in the network entity 1602 may be configured to perform any of the aspects of the flowchart in FIG. 15 and/or the aspects performed by the network node 804 in FIG. 8. The means may be the CJT CSI with TRP selection component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

In some aspects of wireless communication, joint transmission across multiple TRPs may be enabled. The joint transmission may be non-coherent JT (NCJT) in which data (layers) may be precoded separately on different TRPs, or may be CJT in which a same layer may be transmitted via multiple TRPs with phase coherence.

In some aspects, the coherence of CJT refers to a phase coherence between TRPs that may be transmitting a same layer as opposed to NCJT in which each layer is transmitted via a single TRP and phase coherence between the TRPs may not provide additional benefits. In some aspects of wireless communication, CJT may be extended to up to 4 TRPs, e.g., in a low frequency band such as FR1, based on a type-II codebook. In some aspects, providing additional TRPs for CJT effectively increases an antenna size for transmitting the low frequency transmission. In order to indicate a TRP selection (and an associated precoder, e.g., using the eType-II codebook) the present disclosure introduces mechanisms to provide information about TRP selection including mechanisms: (1) to indicate the TRP selection in CSI part 1 with a fixed payload size or (2) to indicate the TRP selection in CSI part 2 with a payload size based on the related CSI part 1.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including transmitting CSI including a first CSI part (CSI part 1) having a fixed payload size and a second CSI part (CSI part 2) having a variable payload size indicated in the CSI part 1, at least one of the CSI part 1 or the CSI part 2 indicating one or more TRPs and transmitting data in a CJT using the one or more TRPs indicated in the at least one of the CSI part 1 or the CSI part 2.

Aspect 2 is the method of aspect 1, where the CSI part 1 includes an indication of the one or more TRPs that is common to each layer of communication using the one or more TRPs.

Aspect 3 is the method of aspect 2, where the indication includes at least one of: a bitmap indicating the one or more TRPs, the indication of the one or more TRPs and the one or more TRPs are restricted with a fixed number, or CRI that indicates the one or more TRPs.

Aspect 4 is the method of any of aspects 1 to 3, where an indication of the one or more TRPs indicated separately for each layer of communication using the one or more TRPs.

Aspect 5 is the method of aspect 4, where the indication is included in the CSI part 2.

Aspect 6 is the method of aspect 5, where the CSI part 1 indicates a total number of TRP selections for all layers and a number of different TRPs in the TRP selections.

Aspect 7 is the method of aspect 6, where the variable payload size of the CSI part 2 is based on a rank indicator and a number of TRPs in the one or more TRPs.

Aspect 8 is the method of aspect 7, where the indication in the CSI part 2 includes RI×N_{TRP} bits, where RI corresponds to the rank indicator and N_{TRP} corresponds to a number of the one or more TRPs.

Aspect 9 is the method of any of aspects 4 to 8, where the CSI part 1 includes a rank indicator per TRP of the one or more TRPs.

Aspect 10 is the method of aspect 9, where a minimum rank indicator is 1.

Aspect 11 is the method of aspect 9, where the rank indicator of zero indicates that the TRP is not selected.

Aspect 12 is the method of aspect 4, where the indication is included in the CSI part 1, and the fixed payload size is based on a maximum rank.

Aspect 13 is the method of any of aspects 1 to 12, where a TRP selection that is common to multiple layers is indicated in the CSI part 1, and a layer specific TRP selection is indicated in the CSI part 2.

Aspect 14 is the method of any of aspects 1 to 13, where a number of NZCs indicated in the CSI part 1 corresponds to a total across the one or more TRPs.

Aspect 15 is the method of any of aspects 1 to 14, where a number of TRPs in each layer equals or decreases with an increase in a layer index.

Aspect 16 is the method of aspect 15, where a first set of selected TRPs of a first layer having a larger index is a subset of a second set of selected TRPs of a second layer having a smaller index.

Aspect 17 is the method of any of aspects 15 and 16, where an overall rank of the coherent joint transmission with multiple TRPs is a maximum rank across each of the multiple TRPs.

Aspect 18 is a method of wireless communication at a base station, including receiving CSI including a first CSI part (CSI part 1) having a fixed payload size and a second CSI part (CSI part 2) having a variable payload size indicated in the CSI part 1, at least one of the CSI part 1 or the CSI part 2 indicating one or more TRPs and receiving data in a CJT using the one or more TRPs indicated in the at least one of the CSI part 1 or the CSI part 2.

Aspect 19 is the method of aspect 18, where the CSI part 1 includes an indication of the one or more TRPs that is common to each layer of communication using the one or more TRPs

Aspect 20 is the method of aspect 19, where the indication includes at least one of: a bitmap indicating the one or more TRPs, the indication of the one or more TRPs and the one or more TRPs are restricted with a fixed number, or CRI that indicates the one or more TRPs.

Aspect 21 is the method of any of aspects 18 to 20, where an indication of the one or more TRPs is indicated separately for each layer of communication using the one or more TRPs.

Aspect 22 is the method of aspect 21, where the indication is included in the CSI part 2 and the CSI part 1 indicates a total number of TRP selections for all layers and a number of different TRPs in the TRP selections.

Aspect 23 is the method of aspect 22, where the variable payload size of the CSI part 2 is based on a rank indicator and a number of TRPs in the one or more TRPs.

Aspect 24 is the method of aspect 23, where the indication in the CSI part 2 includes RI×N_{TRP} bits, where RI corresponds to the rank indicator and N_{TRP} corresponds to a number of the one or more TRPs.

Aspect 25 is the method of any of aspects 21 to 24, where the CSI part 1 includes a rank indicator per TRP of the one or more TRPs.

Aspect 26 is the method of aspect 25, where a minimum rank indicator is 1 or a rank indicator of zero indicates that the TRP is not selected.

Aspect 27 is the method of aspect 21, where the indication is included in the CSI part 1, and the fixed payload size is based on a maximum rank.

Aspect 28 is the method of any of aspects 18 to 27, where a TRP selection that is common to multiple layers is indicated in the CSI part 1, and a layer specific TRP selection is indicated in the CSI part 2.

Aspect 29 is the method of any of aspects 18 to 28, where a number of NZCs indicated in the CSI part 1 corresponds to a total across the one or more TRPs.

Aspect 30 is the method of any of aspects 18 to 29, where a number of TRPs in each layer equals or decreases with an increase in a layer index.

Aspect 31 is the method of aspect 30, where a first set of selected TRPs of a first layer having a larger index is a subset of a second set of selected TRPs of a second layer having a smaller index.

Aspect 32 is the method of any of aspects 30 and 31, where an overall rank of the coherent joint transmission with multiple TRPs is a maximum rank across each of the multiple TRPs.

Aspect 33 is an apparatus for wireless communication including a memory and at least one processor coupled to the memory and, based at least in part on information stored in the memory, the at least one processor is configured to implement any of aspects 1 to 32.

Aspect 34 is an apparatus for wireless communication including means for implementing any of aspects 1 to 32.

Aspect 35 is a computer-readable medium storing computer executable code, where the code when executed by a processor causes the processor to implement any of aspects 1 to 32.

What is claimed is:

1. An apparatus for wireless communication, comprising:
memory; and
at least one processor coupled to the memory and configured to:
transmit channel state information (CSI) including a first CSI part (CSI part 1) having a fixed payload size and a second CSI part (CSI part 2) having a variable payload size indicated in the CSI part 1, at least one of the CSI part 1 or the CSI part 2 indicating one or more transmission reception points (TRPs); and
transmit data in a coherent joint transmission using the one or more TRPs indicated in the at least one of the CSI part 1 or the CSI part 2.

2. The apparatus of claim 1, wherein the CSI part 1 includes an indication of the one or more TRPs that is common to each layer of communication using the one or more TRPs.

3. The apparatus of claim 2, wherein the indication comprises at least one of:
a bitmap indicating the one or more TRPs,
the indication of the one or more TRPs and the one or more TRPs are restricted with a fixed number, or
channel state information reference signal (CSI) resource indicator (CRI) that indicates the one or more TRPs.

4. The apparatus of claim 1, wherein an indication of the one or more TRPs is indicated separately for each layer of communication using the one or more TRPs.

5. The apparatus of claim 4, wherein the indication is included in the CSI part 2.

6. The apparatus of claim 5, wherein the CSI part 1 indicates a total number of TRP selections for all layers and a number of different TRPs in the TRP selections.

7. The apparatus of claim 6, wherein the variable payload size of the CSI part 2 is based on a rank indicator and a number of TRPs in the one or more TRPs.

8. The apparatus of claim 7, wherein the indication in the CSI part 2 includes RI×N_{TRP} bits, where RI corresponds to the rank indicator and N_{TRP} corresponds to a number of the one or more TRPs.

9. The apparatus of claim 4, wherein the CSI part 1 includes a rank indicator per TRP of the one or more TRPs.

10. The apparatus of claim 9, wherein a minimum rank indicator is 1.

11. The apparatus of claim 9, wherein the rank indicator of zero indicates that the TRP is not selected.

12. The apparatus of claim 4, wherein the indication is included in the CSI part 1, and the fixed payload size is based on a maximum rank.

13. The apparatus of claim 1, wherein a TRP selection that is common to multiple layers is indicated in the CSI part 1, and a layer specific TRP selection is indicated in the CSI part 2.

14. The apparatus of claim 1, wherein a number of non-zero coefficients (NZCs) indicated in the CSI part 1 corresponds to a total across the one or more TRPs.

15. The apparatus of claim 1, wherein a number of TRPs in each layer equals or decreases with an increase in a layer index.

16. The apparatus of claim 15, wherein a first set of selected TRPs of a first layer having a larger index is a subset of a second set of selected TRPs of a second layer having a smaller index.

17. The apparatus of claim 15, wherein an overall rank of the coherent joint transmission with multiple TRPs is a maximum rank across each of the multiple TRPs.

18. The apparatus of claim 1, further comprising:
at least one transceiver or at least one antenna coupled to the at least one processor and configured to transmit the CSI and the data.

19. An apparatus for wireless communication, comprising:
memory; and
at least one processor coupled to the memory and configured to:
receive channel state information (CSI) including a first CSI part (CSI part 1) having a fixed payload size and a second CSI part (CSI part 2) having a variable payload size indicated in the CSI part 1, at least one of the CSI part 1 or the CSI part 2 indicating one or more transmission reception points (TRPs); and
receive data in a coherent joint transmission using the one or more TRPs indicated in the at least one of the CSI part 1 or the CSI part 2.

20. The apparatus of claim 19, wherein the CSI part 1 includes an indication of the one or more TRPs that is common to each layer of communication using the one or more TRPs, wherein the indication comprises at least one of:
a bitmap indicating the one or more TRPs,
the indication of the one or more TRPs and the one or more TRPs are restricted with a fixed number, or
channel state information reference signal (CSI) resource indicator (CRI) that indicates the one or more TRPs.

21. The apparatus of claim 19, wherein an indication of the one or more TRPs is indicated separately for each layer of communication using the one or more TRPs.

22. The apparatus of claim 21, wherein the indication is included in the CSI part 2, the CSI part 1 indicating a total number of TRP selections for all layers and a number of different TRPs in the TRP selections, and wherein the variable payload size of the CSI part 2 is based on a rank indicator and a number of TRPs in the one or more TRPs.

23. The apparatus of claim 21, wherein the CSI part 1 includes a rank indicator per TRP of the one or more TRPs.

24. The apparatus of claim 21, wherein the indication is included in the CSI part 1, and the fixed payload size is based on a maximum rank.

25. The apparatus of claim 19, wherein a TRP selection that is common to multiple layers is indicated in the CSI part 1, and a layer specific TRP selection is indicated in the CSI part 2.

26. The apparatus of claim 19, wherein a number of NZCs indicated in the CSI part 1 corresponds to a total across the one or more TRPs.

27. The apparatus of claim 19, wherein a number of TRPs in each layer equals or decreases with an increase in a layer index.

28. The apparatus of claim 19, further comprising:
at least one transceiver or at least one antenna coupled to the at least one processor and configured to receive the CSI and the data.

29. A method of wireless communication, comprising:
transmitting channel state information (CSI) including a first CSI part (CSI part 1) having a fixed payload size and a second CSI part (CSI part 2) having a variable payload size indicated in the CSI part 1, at least one of the CSI part 1 or the CSI part 2 indicating one or more transmission reception points (TRPs); and
transmitting data in a coherent joint transmission using the one or more TRPs indicated in the at least one of the CSI part 1 or the CSI part 2.

30. A method of wireless communication, comprising:
receiving channel state information (CSI) including a first CSI part (CSI part 1) having a fixed payload size and a second CSI part (CSI part 2) having a variable payload size indicated in the CSI part 1, at least one of the CSI part 1 or the CSI part 2 indicating one or more transmission reception points (TRPs); and
receiving data in a coherent joint transmission using the one or more TRPs indicated in the at least one of the CSI part 1 or the CSI part 2.
